(19) United States
(12) Patent Application Publication
(10) Pub. No.: US 2011/0043718 A1
(43) Pub. Date: Feb. 24, 2011

(54) Pixel Circuit Structure of Display

(76) Inventor: Yin-Shuan CHIN, Taipei City (TW)

Correspondence Address: LanWay IPR Services, P.O. Box 220746, Chantilly, VA, 20153, US

(21) Appl. No.: 12/545,055

(22) Filed: Aug. 20, 2009

(51) Int. Cl. G02F 1/1343; G02F 1/133

(52) U.S. Cl. 349/39; 349/116

(57) ABSTRACT

A pixel circuit structure of a display includes a pixel unit, a light sensing element, a light sensing storage capacitor, a data reading element, and a co-electrode line. The pixel unit has a main pixel and a sub-pixel, the main pixel is coupled to the sub-pixel by a coupling capacitor, and the main pixel is further coupled to a data line and a gate line perpendicular to the data line. A first end of the light sensing element is coupled to the pixel unit. The light sensing storage capacitor is coupled to the light sensing element, and used for storing data of the data line. The data reading element is respectively coupled to the light sensing element, a read data line, and the gate line. The co-electrode line provides a bias voltage for the main pixel, the sub-pixel, the light sensing element, and the light sensing storage capacitor.

### BACKGROUND OF THE INVENTION

1. Field of the Invention

The present invention relates to a circuit structure of a display, and more particularly to a pixel circuit structure of a display having a wide viewing angle pixel and capable of sensing light intensity by using a light sensing transistor so as to move a frame.

2. Related Art

A thin film transistor (TFT) liquid crystal display (LCD) is an active matrix display device. A structure of the TFT LCD mainly includes a transparent substrate, and a gate driving circuit, a source driving circuit, a TFT pixel array, a plurality of gate lines, and a plurality of data lines disposed on the transparent substrate. The TFT pixel array further includes a plurality of pixel units. The plurality of pixel units is respectively disposed on crossed positions of the gate lines and the data lines, and is electrically coupled to the corresponding gate lines and the corresponding data lines. Each pixel unit includes a TFT and a pixel electrode electrically connected to the TFT. The gate driving circuit provides an image data signal for the data line, so as to realize an image display function.

Recently, due to its light weight, low power consumption, and other features, the TFT LCD has been widely applied to various handheld electronic devices, for example, personal computers (PCs), mobile phones, and personal digital assistants (PDAs). In order to meet thin and light demands of various handheld electronic devices, an LCD having an optical touch pixel circuit structure is proposed.

FIG. 1 shows a conventional pixel circuit structure. Referring to FIG. 1, pixel TFTs Qn and Qn-1 are coupled to a data line DL and a gate line GL at the same time. A liquid crystal capacitor Clc and a storage capacitor Cst are charged through an action of the pixel TFT Qn. A light sensing TFT Qp is enabled to act by applying a bias voltage Vbias thereto, so as to charge a storage capacitor Cst2. When a shield exists, a light quantity sensed by the light sensing TFT Qp is changed. Based on the light quantity sensed by the light sensing TFT Qp, a light leakage current is generated, which differs from a current produced by the originally applied bias voltage Vbias, thereby changing a charging voltage of the storage capacitor Cst2. When a next frame signal arrives, a gate line GL signal is actuated, that is, the pixel TFT Qn-1 starts to act, so that for a changed storage voltage value, charges stored in the storage capacitor Cst2 are read by a read TFT Qsw through a read data line RDL. Then, a signal processing is performed by using a reference voltage Vref (5V) and an amplifier Amp, so as to sense a change of the light irradiation quantity resulting from a touch.

FIG. 2 shows another conventional pixel circuit structure. Referring to FIG. 2, one end of a TFT sensor Qs is coupled to a driving voltage Vdr, and an LCD TFT Qlcd is respectively coupled to a data line DL and a gate line GL. A liquid crystal capacitor Clc and a storage capacitor Cst1 are charged through an action of the LCD TFT Qlcd, i.e., an action of a gate line voltage Vg(n). The TFT sensor Qs is enabled to act by applying a bias voltage Vbias thereto, so as to charge a storage capacitor Cst2. When a shield exists, a light quantity sensed by the TFT sensor Qs is changed. Based on the light quantity sensed by the TFT sensor Qs, a light leakage current is generated, which differs from a current produced by the originally applied bias voltage Vbias, thereby changing a charging voltage of the storage capacitor Cst2. When a next frame signal arrives, i.e., a gate line voltage Vg(n-1) is actuated, for a changed storage voltage value, charges stored in the storage capacitor Cst2, i.e., a voltage value of a voltage Vro, are read through a TFT switch Qsw1, so as to determine whether a scanning object is sensed or not.

### SUMMARY OF THE INVENTION

Accordingly, the present invention is directed to a pixel circuit structure of a display, so as to achieve an 8-domain wide viewing angle display effect.

The present invention is also directed to a process of discharging residual charges resulting from a coupling capacitor in a sub-pixel by a data reading element (read TFT), so as to improve the display quality of a display panel.

The present invention is further directed to a manufacturing process following a conventional TFT five-step manufacturing process without increasing the cost or the complexity of the process.

In order to achieve the above objectives, a pixel circuit structure of a display is provided in the present invention. The pixel circuit structure of the display comprise a pixel unit, a light sensing element, a light sensing storage capacitor, a data reading element and a co-electrode line. The pixel unit has a main pixel and a sub-pixel, wherein the main pixel is coupled to the sub-pixel in the pixel unit by using a coupling capacitor, and the main pixel is further coupled to a data line and a gate line perpendicular to the data line. The light sensing element has a first end and a second end, wherein the first end is coupled to the pixel unit. The light sensing storage capacitor is coupled to the second end of the light sensing element, and used for storing data of the data line. The data reading element is respectively coupled to the second end of the light sensing element, a read data line, and the gate line. The co-electrode line is used for providing a bias voltage for the main pixel, the sub-pixel, the light sensing element, and the light sensing storage capacitor.

In an embodiment of the present invention, the main pixel further comprises a main transistor element, a gate of the main transistor element is coupled to the gate line, a source of the main transistor element is coupled to the data line, and a drain of the main transistor element is coupled to the coupling capacitor.

In an embodiment of the present invention, the main pixel further comprises a first liquid crystal capacitor and a first storage capacitor, and the first storage capacitor of the main pixel is coupled to the co-electrode line.

In an embodiment of the present invention, the sub-pixel further comprises a second liquid crystal capacitor and a second storage capacitor, and the second storage capacitor of the sub-pixel is coupled to the co-electrode line.

In an embodiment of the present invention, the light sensing element is a light sensing thin film transistor (TFT), and a source of the light sensing TFT is coupled to the main pixel. The data reading element is a read TFT, and a gate of the read TFT is coupled to the gate line or a gate line of another pixel circuit structure.

In an embodiment of the present invention, the light sensing element is a light sensing thin film transistor (TFT), and a source of the light sensing TFT is coupled to the sub-pixel. The data reading element is a read TFT, and a gate of the read TFT is coupled to the gate line or a gate line of another pixel circuit structure.

### BRIEF DESCRIPTION OF THE DRAWINGS

The present invention will become more fully understood from the detailed description given herein below for illustration only, and thus are not limitative of the present invention, and wherein:

FIG. 1 shows a conventional pixel circuit structure;

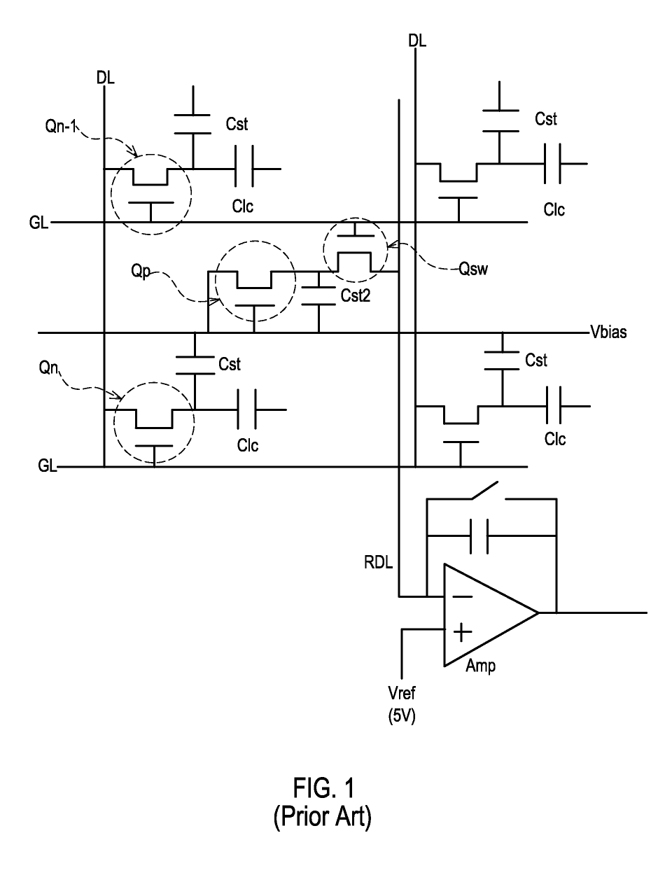

FIG. 2 shows another conventional pixel circuit structure;

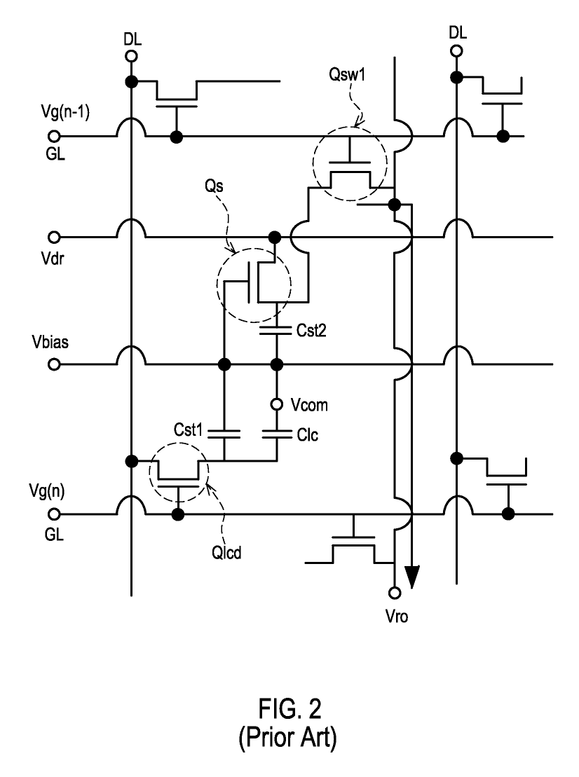

FIG. 3 is a circuit diagram of a first embodiment of the present invention;

FIG. 4 is an operating diagram of the first embodiment of the present invention when a mask does not exist;

FIG. 5 is an operating diagram of the first embodiment of the present invention when a mask exists;

FIG. 6 is a circuit diagram of a second embodiment of the present invention;

FIG. 7 is a circuit diagram of a third embodiment of the present invention; and

FIG. 8 is a circuit diagram of a fourth embodiment of the present invention.

### DETAILED DESCRIPTION OF THE INVENTION

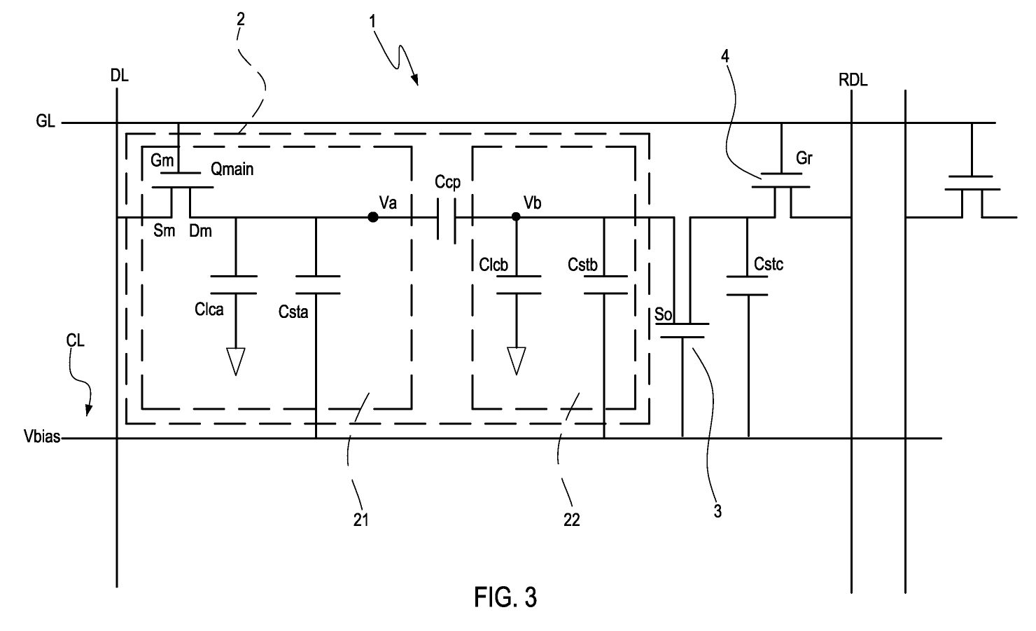

FIG. 3 is a circuit diagram of a first embodiment of the present invention. Referring to FIG. 3, a pixel circuit structure 1 of this embodiment includes a pixel unit 2, a light sensing element 3, a light sensing storage capacitor Cstc, a data reading element 4, and a co-electrode line CL.

The pixel unit 2 has a main pixel 21 and a sub-pixel 22. The main pixel 21 is coupled to the sub-pixel 22 in the pixel unit 2 by using a coupling capacitor Ccp, and the voltages of the two pixels 21, 22 are respectively Va and Vb. The main pixel 21 is further coupled to a data line DL and a gate line GL perpendicular to the data line DL. The main pixel 21 has a main transistor element Qmain. A gate Gm of the Qmain is coupled to the gate line GL, a source Sm is coupled to the data line DL, and a drain Dm is coupled to a first end of the coupling capacitor Ccp. The main pixel 21 further includes a first liquid crystal capacitor Clca and a first storage capacitor Csta, and the first storage capacitor Csta of the main pixel 21 is coupled to the co-electrode line CL.

The sub-pixel 22 has a second liquid crystal capacitor Clcb and a second storage capacitor Cstb, and the second storage capacitor Cstb of the sub-pixel 22 is coupled to the co-electrode line CL.

A first end of the light sensing element 3 is coupled to the pixel unit 2. The light sensing element 3 is a light sensing TFT, and a source So thereof is coupled to the sub-pixel 22.

The light sensing storage capacitor Cstc is coupled to a second end of the light sensing element 3, and used for storing data of the data line DL.

The data reading element 4 is respectively coupled to the second end of the light sensing element 3, a read data line RDL, and the gate line GL. The data reading element 4 is a read TFT, and a gate Gr thereof is coupled to the gate line GL.

The co-electrode line CL provides a bias voltage Vbias for the main pixel 21, the sub-pixel 22, the light sensing element 3, and the light sensing storage capacitor Cstc.

The pixel unit 2 is divided into the main pixel 21 and the sub-pixel 22, and a voltage relation there-between is shown in Equation one as follows.

$$Vb = Va \times \frac{Ccp}{Ccp + Clcb + Cstb + Cstc} \qquad Equation one$$

Due to different coupling voltages, the voltages of the main pixel 21 and the sub-pixel 22 are also different, so as to generate an 8-domain effect. A function of the light sensing element 3 is to sense a light irradiation quantity (i.e., light irradiation intensity). The voltage Vb is applied, such that through a difference between an originally provided current and a light leakage current, the light sensing storage capacitor Cstc is charged. The data reading element 4 reads charges stored in the light sensing storage capacitor Cstc through the read data line RDL, so as to sense whether the light sensing element 3 is touched or not.

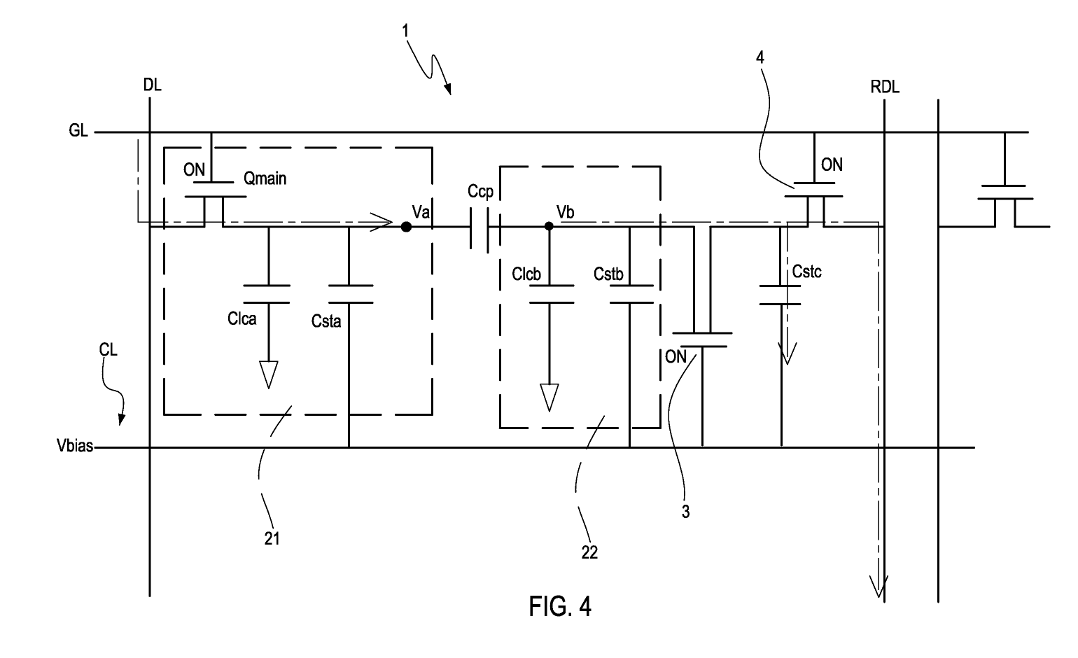

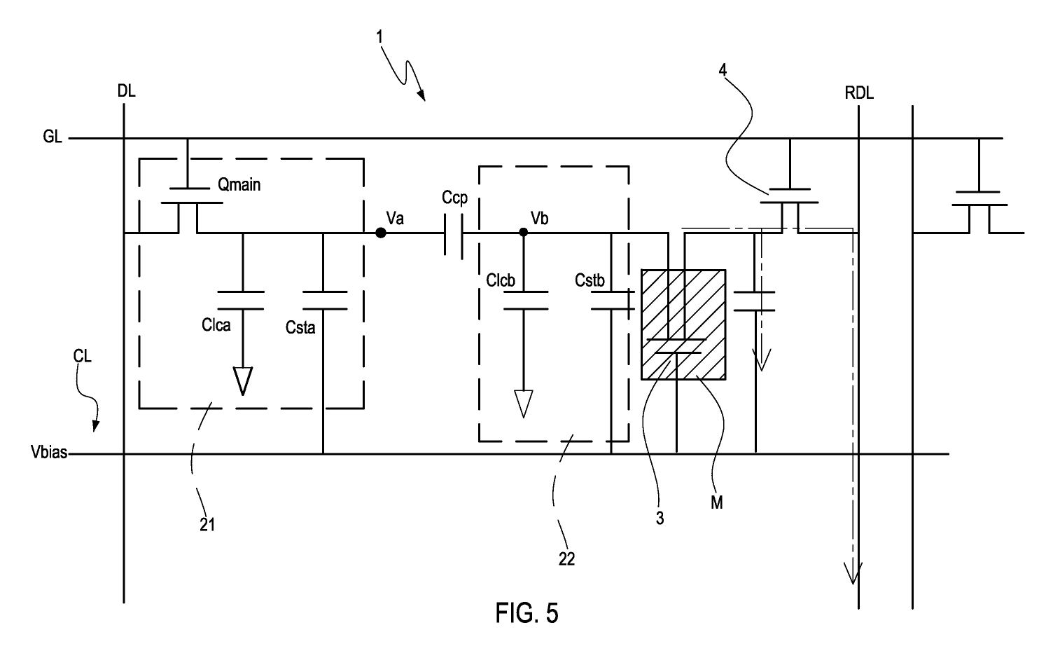

FIGS. 4 and 5 are respectively operating diagrams of the embodiment of the present invention when a mask does not exist and when a mask exists. Referring to FIGS. 4 and 5, in this embodiment, the sub-pixel 22 is coupled to the light sensing element 3 and the data reading element 4. When the gate line GL signal is actuated, the main transistor element Qmain and the data reading element 4 start to act. The coupling capacitor Ccp is coupled to the voltage Vb of the sub-pixel 22, and when the bias voltage Vbias is applied, the light sensing element 3 connected to the co-electrode line CL is also actuated. Therefore, the voltage Vb also charges the light sensing storage capacitor Cstc. At this time, if a mask does not exist (as shown in FIG. 4), the light leakage current of the light sensing element 3 is not changed, and no touch action is sensed through the data read by the data reading element 4, so that the frame may not be moved. If a mask M exists (as shown in FIG. 5), the light leakage current of the light sensing element 3 is changed, and the changed charges are stored in the light sensing storage capacitor Cstc. When started the next time, the data reading element 4 reads the changed voltage, and determines that a touch action is performed, so that the frame may be moved accordingly.

In FIG. 5, as the coupling capacitor Ccp is coupled to the voltage Vb of the sub-pixel 22, a signal delay occurs. Therefore, when the data reading element 4 is actuated, the impact on the voltage Vb of the sub-pixel 22 is lowered. In addition, as a width-to-length ratio (W/L) of the data reading element 4 is reduced, the impact on the voltage Vb of the sub-pixel 22 is also lowered.

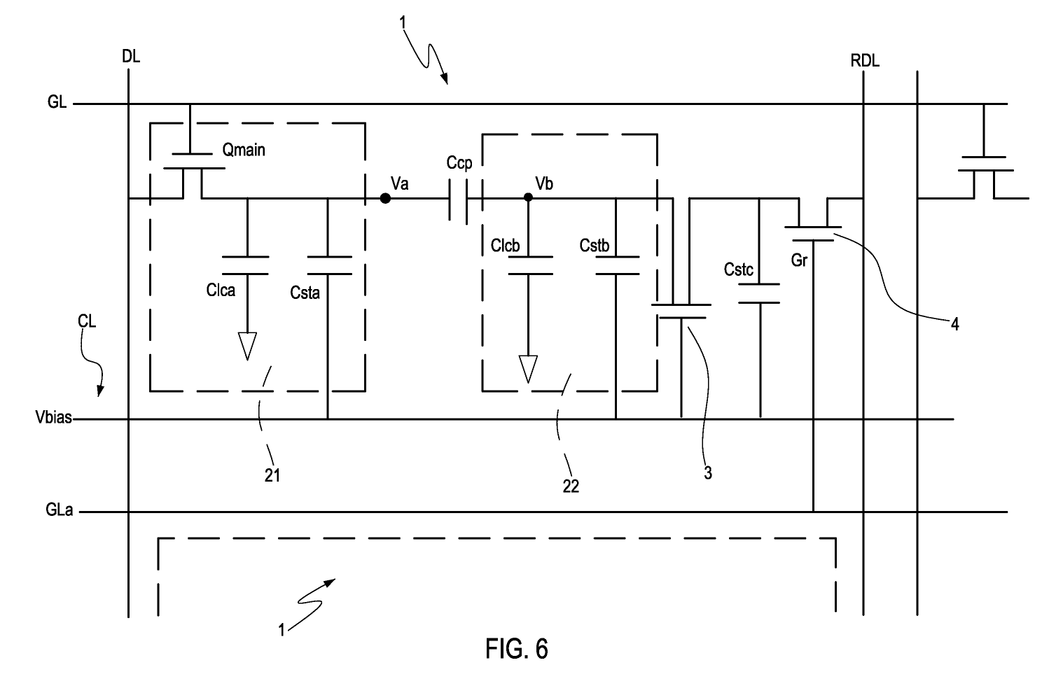

FIG. 6 is a circuit diagram of a second embodiment of the present invention. Referring to FIG. 6, in a pixel circuit structure 1 of this embodiment, a gate Gr of a data reading element 4 is connected to a gate line GLa of another pixel circuit structure 1.

In the structure of this embodiment, when the data reading element 4 is actuated, the impact on a voltage Vb of a sub-pixel 22 is lowered. Therefore, when the data reading element 4 is actuated, only a changed voltage value of a light sensing storage capacitor Cstc is read, and the efficacy of the first embodiment may also be achieved.

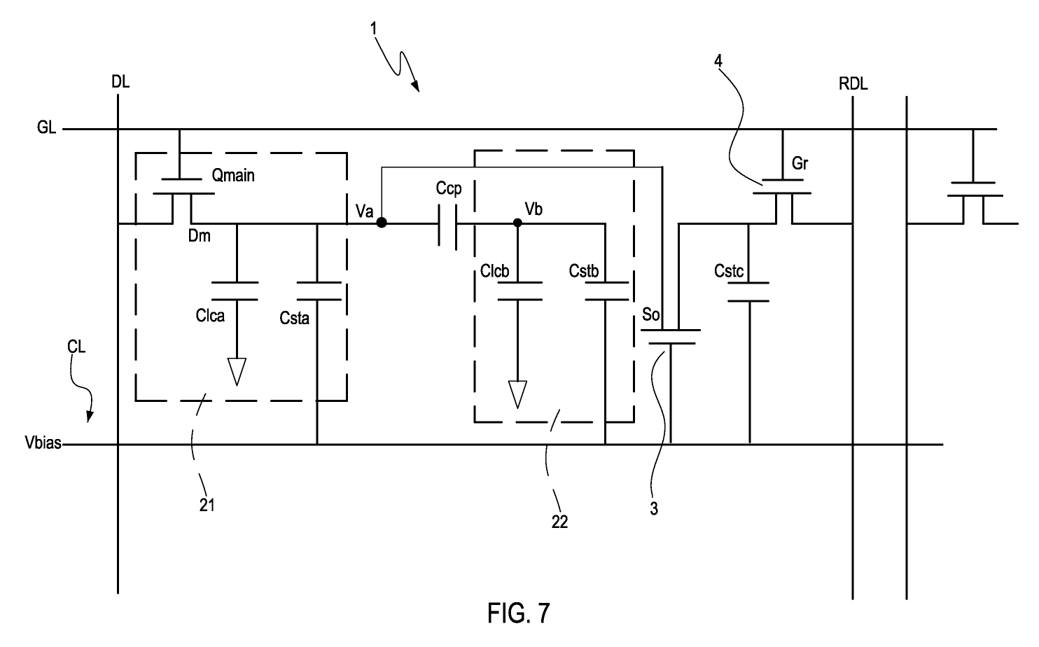

FIG. 7 is a circuit diagram of a third embodiment of the present invention. Referring to FIG. 7, in a pixel circuit structure 1 of this embodiment, a source So of a light sensing element 3 is connected to a main pixel 21. Particularly, the source So of the light sensing element 3 is connected to a drain Dm of the main pixel 21.

In this embodiment, the light sensing element 3 is coupled to the main pixel 21, the impact on a voltage Vb of a sub-pixel 22 is lowered, and a relation between a voltage Va of the main pixel 21 and the voltage Vb of the sub-pixel 22 is shown in Equation two. The efficacy of the first embodiment may also be achieved.

$$Vb = Va \times \frac{Ccp}{Ccp + Clcb + Cstb} \qquad Equation two$$

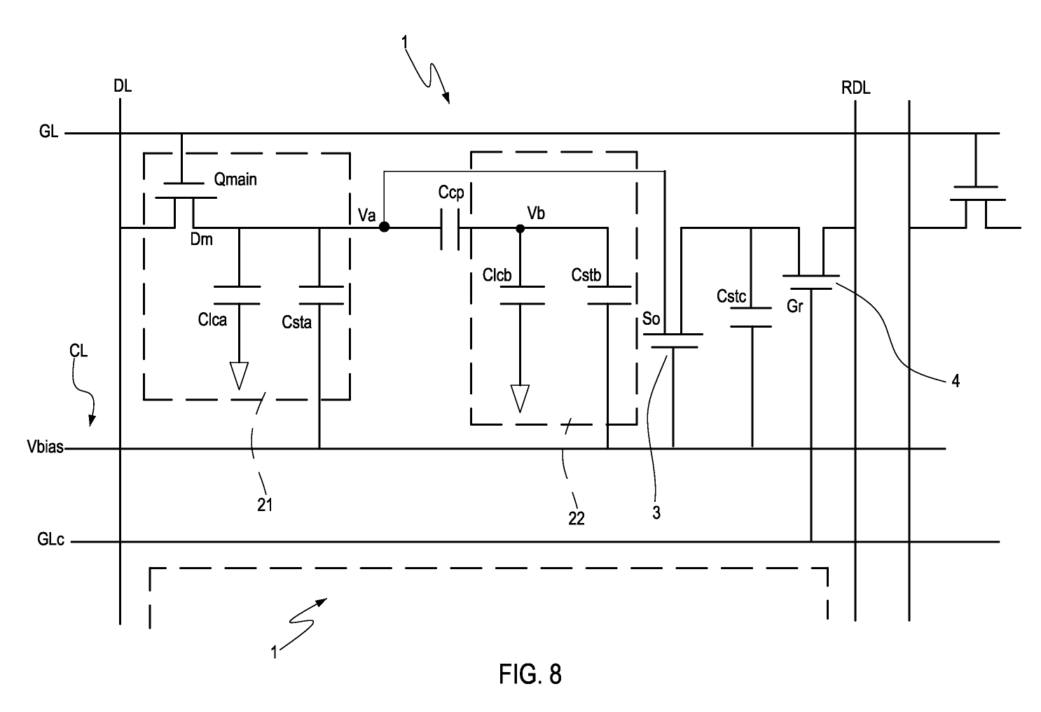

FIG. 8 is a circuit diagram of a fourth embodiment of the present invention. Referring to FIG. 8, in a pixel circuit structure 1 of this embodiment, a gate Gr of a data reading element 4 is connected to a gate line GLc of another pixel circuit structure 1, and a source So of a light sensing element 3 is connected to a main pixel 21. Particularly, the source So of the light sensing element 3 is connected to a drain Dm of the main pixel 21.

In this embodiment, the light sensing element 3 is coupled to the main pixel 21, and the gate Gr of the data reading element 4 is connected to the gate line GLc of another pixel circuit structure 1, so that the sub-pixel 22 of this embodiment is completely not affected by a voltage of an external sensor, and the efficacy of the first embodiment may also be achieved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pixel circuit structure of a display, comprising:
a pixel unit, having a main pixel and a sub-pixel, wherein the main pixel is coupled to the sub-pixel in the pixel unit by using a coupling capacitor, and the main pixel is further coupled to a data line and a gate line perpendicular to the data line;
a light sensing element, having a first end and a second end, wherein the first end is coupled to the pixel unit;
a light sensing storage capacitor, coupled to the second end of the light sensing element, and used for storing data of the data line;
a data reading element, respectively coupled to the second end of the light sensing element, a read data line, and the gate line; and
a co-electrode line, for providing a bias voltage for the main pixel, the sub-pixel, the light sensing element, and the light sensing storage capacitor.

2. The pixel circuit structure according to claim 1, wherein the main pixel further comprises a main transistor element, a gate of the main transistor element is coupled to the gate line, a source of the main transistor element is coupled to the data line, and a drain of the main transistor element is coupled to the coupling capacitor.

3. The pixel circuit structure according to claim 1, wherein the main pixel further comprises a first liquid crystal capacitor and a first storage capacitor, and the first storage capacitor of the main pixel is coupled to the co-electrode line.

4. The pixel circuit structure according to claim 1, wherein the sub-pixel further comprises a second liquid crystal capacitor and a second storage capacitor, and the second storage capacitor of the sub-pixel is coupled to the co-electrode line.

5. The pixel circuit structure according to claim 1, wherein the light sensing element is a light sensing thin film transistor (TFT), and a source of the light sensing TFT is coupled to the main pixel.

6. The pixel circuit structure according to claim 1, wherein the light sensing element is a light sensing TFT, and a source of the light sensing TFT is coupled to the sub-pixel.

7. The pixel circuit structure according to claim 1, wherein the data reading element is a read TFT, and a gate of the read TFT is coupled to the gate line.

8. The pixel circuit structure according to claim 1, wherein the data reading element is a read TFT, and a gate of the read TFT is coupled to a gate line of a pixel of a next frame.
